(19) United States
(12) Patent Application Publication
(10) Pub. No.: US 2012/0150700 A1
(43) Pub. Date: Jun. 14, 2012

(54) METHOD AND SYSTEM FOR DISTRIBUTING INVENTORY OF A REPLACED OR DISCONTINUED DISTRIBUTION CENTER PRODUCT

(76) Inventors: Ziauddin Babar, Mississauga (CA); Blazimir Radovic, Toronto (CA); Ejaz Haider, Markham (CA)

(21) Appl. No.: 12/966,154

(22) Filed: Dec. 13, 2010

(51) Int. Cl. G06Q 10/00

(52) U.S. Cl. 705/28

(57) ABSTRACT

A method and system for distributing inventory of a replaced or discontinued product from a warehouse or distribution center to a plurality of stores. The method optimally distributes the inventory of the replaced or discontinued product from the distribution center, keeping in mind the demand for a replacing product at the stores supported by the distribution center. The described system and method calculates replaced (old) and replacing (new) store product order quantities; rounds the replaced and replacing product order quantities if necessary due to product packaging; and ensures that the aggregate of the replaced product order quantity does not exceed distribution center on-hand inventory for the replaced product.

### FIELD OF THE INVENTION

The present invention relates to methods and systems for distributing the remaining inventory of a replaced or discontinued product at a distribution center or warehouse.

### BACKGROUND OF THE INVENTION

Today's competitive business environment demands that retailers be more efficient in managing their inventory levels to reduce costs and yet fulfill demand. To accomplish this, many retailers are developing strong partnerships with their vendors/suppliers to set and deliver common goals. One of the key business objectives both the retailer and vendor are striving to meet is customer satisfaction by having the right merchandise in the right locations at the right time. To that effect it is important that vendor production and deliveries become more efficient. The inability of retailers and suppliers to synchronize the effective distribution of goods through the distribution facilities to the stores has been a major impediment to both maximizing productivity throughout the demand chain and effectively responding to the needs of the consumer.

Teradata Corporation has developed a suite of analytical applications for the retail business, referred to as Teradata Demand Chain Management (DCM), which provides retailers with the tools they need for product demand forecasting, planning and replenishment. Teradata Demand Chain Management assists retailers in accurately forecasting product sales at the store/SKU (Stock Keeping Unit) level to ensure high customer service levels are met, and inventory stock at the store level is optimized and automatically replenished. The individual store product forecasts can thereafter be accumulated and used to determine the appropriate amounts of products to order from a product warehouse or distribution center to meet customer demand. The warehouse must in turn order appropriate amounts from suppliers and vendors based on its demand forecast.

The discontinuance or replacement of a product maintained at a distribution center raises questions regarding how best to discharge and fairly distribute the lingering inventory of the discontinued or replaced product. Described below is a method for clearing out the inventory of a discontinued or replaced product at a distribution center.

### BRIEF DESCRIPTION OF THE DRAWINGS

FIG. 1 provides an illustration of a product supply/demand chain from a supplier and manufacturer to a retail store and customer.

FIG. 2 is process flow diagram illustrating a synchronized DC/warehouse forecasting and replenishment process.

FIG. 3 provides a high level architecture diagram of a web-based three-tier client-server computer system architecture.

FIG. 4 provides an illustration of a forecasting, planning and replenishment software application suite for the retail industries built upon Teradata Corporation's Teradata Data Warehouse.

FIG. 5 provides a flow diagram of a process for optimally clearing out the inventory of a replaced/discontinued product at a Distribution Center in accordance with the present invention.

FIG. 6 provides an illustration of sample results of the process for optimally clearing out the inventory of a replaced/discontinued product shown in FIG. 5.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

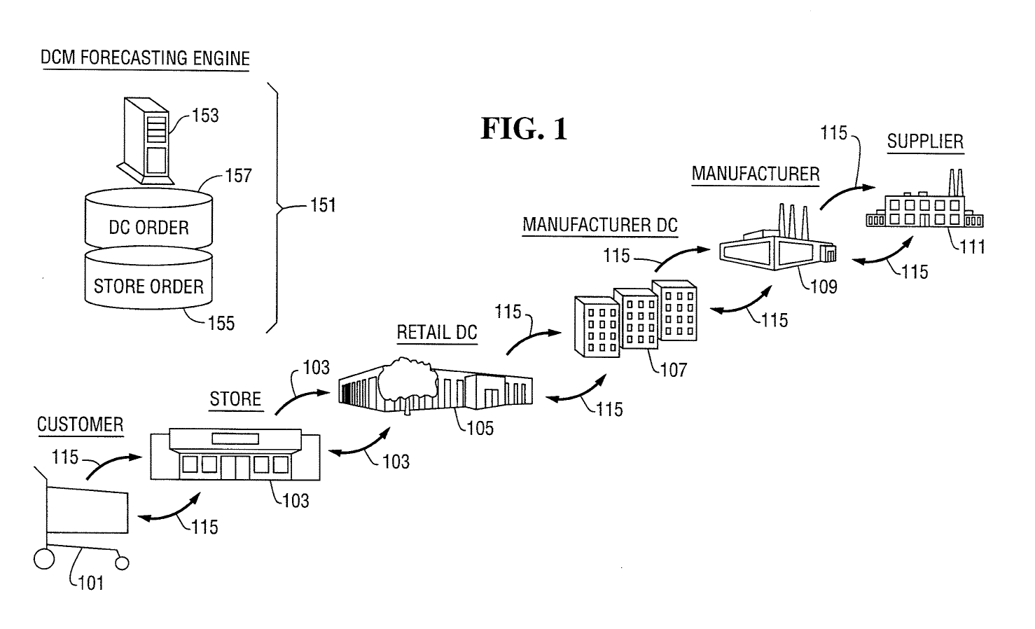

FIG. 1 provides an illustration of a retail demand/supply chain from a customer 101 to a retail store 103, retail distribution center/warehouse 105, manufacturer distribution center/warehouse 107, manufacturer 109 and supplier 111. Arrows 115 are used to illustrate communication between the demand/supply chain entities. The Teradata Demand Chain Management system, identified by reference numeral 151, includes product demand forecasting, planning and replenishment applications executed on a server 153 to determine store order quantities 155 and distribution center forecasts 157, and provides for the synchronization of the warehouse/distribution center replenishment system with the replenishment ordering system from their supported stores.

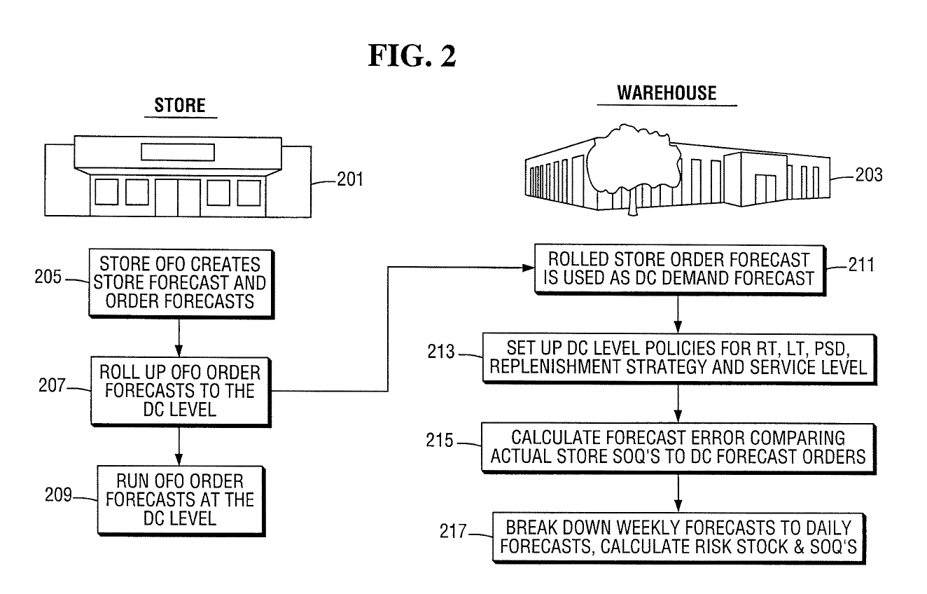

A synchronized DC/warehouse forecasting and replenishment process is illustrated in the process flow diagram of FIG. 2. Beginning at step 205, each retail store 201 supplied by warehouse 203 creates a store forecast and order forecast. In step 207, the individual store order forecasts are accumulated to the DC/warehouse level. This rolled-up order forecast is provided to the DC/warehouse 203 for use as the DC/warehouse demand forecast, as shown in step 211.

In step 213, DC/warehouse level policies may be established for RT (Review Time from last time the replenishment system was run), LT (Lead Time from the order being cut to the delivery of product), PSD (Planned Sales Days, the amount of time the Effective Inventory should service the forecast demand), Replenishment Strategy, and Service Level. In step 215, forecast error is calculated comparing actual store suggested order quantities (SOQs) to DC/warehouse forecast orders. Finally, in step 217, weekly forecasts are broken down to determine daily forecasts, calculate safety stock and SOQs. Safety Stock is the statistical risk stock needed to meet a certain service level for a given order quantity. The safety stock is a function of lead times, planned sales days, service level and forecast error.

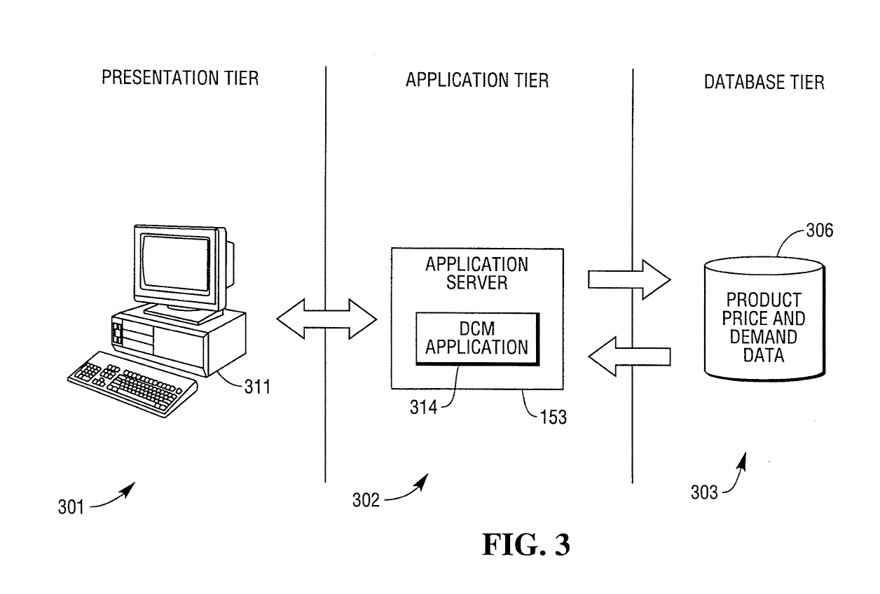

The Teradata Corporation DCM Application Suite may be implemented within a three-tier computer system architecture as illustrated in FIG. 3. The three-tier computer system architecture is a client-server architecture in which the user interface, application logic, and data storage and data access are developed and maintained as independent modules, most often on separate platforms. The three tiers are identified in FIG. 3 as presentation tier 301, application tier 302, and database access tier 303.

Presentation tier 301 includes a PC or workstation 311 and standard graphical user interface enabling user interaction with the DCM application and displaying DCM output results to the user. Application tier 303 includes an application server 153 hosting the DCM software application 314. Database tier 303 includes a database server containing a database 316 of product price and demand data accessed by DCM application 314.

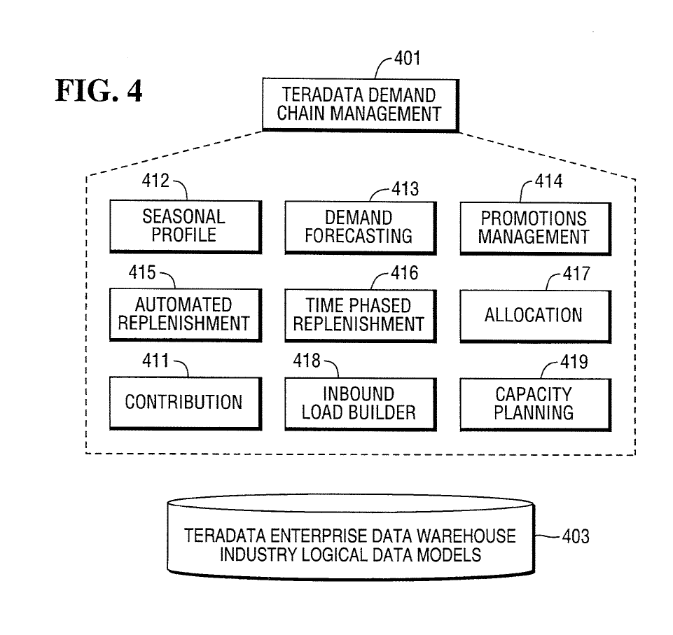

As illustrated in FIG. 4 the Teradata Demand Chain Management analytical application suite 401 is shown to be part of a data warehouse solution for the retail industries built upon Teradata Corporation's Teradata Data

Warehouse 403, using a Teradata Retail Logical Data Model (RLDM). The key modules contained within the Teradata Demand Chain Management application suite 401, are:

Contribution: Contribution module 411 provides an automatic categorization of SKUs, merchandise categories and locations based on their contribution to the success of the business. These rankings are used by the replenishment system to ensure the service levels, replenishment rules and space allocation are constantly favoring those items preferred by the customer.

Seasonal Profile: The Seasonal Profile module 412 automatically calculates seasonal selling patterns at all levels of merchandise and location. This module draws on historical sales data to automatically create seasonal models for groups of items with similar seasonal patterns. The model might contain the effects of promotions, markdowns, and items with different seasonal tendencies.

Demand Forecasting: The Demand Forecasting module 413 provides store/SKU level forecasting that responds to unique local customer demand. This module considers both an item's seasonality and its rate of sales (sales trend) to generate an accurate forecast. The module continually compares historical and current demand data and utilizes several methods to determine the best product demand forecast.

Promotions Management: The Promotions Management module 414 automatically calculates the precise additional stock needed to meet demand resulting from promotional activity.

Automated Replenishment: Automated Replenishment module 415 provides the retailer with the ability to manage replenishment both at the distribution center and the store levels. The module provides suggested order quantities based on business policies, service levels, forecast error, risk stock, review times, and lead times.

Time Phased Replenishment: Time Phased Replenishment module 416 Provides a weekly long-range order forecast that can be shared with vendors to facilitate collaborative planning and order execution. Logistical and ordering constraints such as lead times, review times, service-level targets, min/max shelf levels, etc. can be simulated to improve the synchronization of ordering with individual store requirements.

Allocation: The Allocation module 417 uses intelligent forecasting methods to manage pre-allocation, purchase order and distribution center on-hand allocation.

Load Builder: Load Builder module 418 optimizes the inventory deliveries coming from the distribution centers (DCs) and going to the retailer's stores. It enables the retailer to review and optimize planned loads.

Capacity Planning: Capacity Planning module 419 looks at the available throughput of a retailer's supply chain to identify when available capacity will be exceeded.

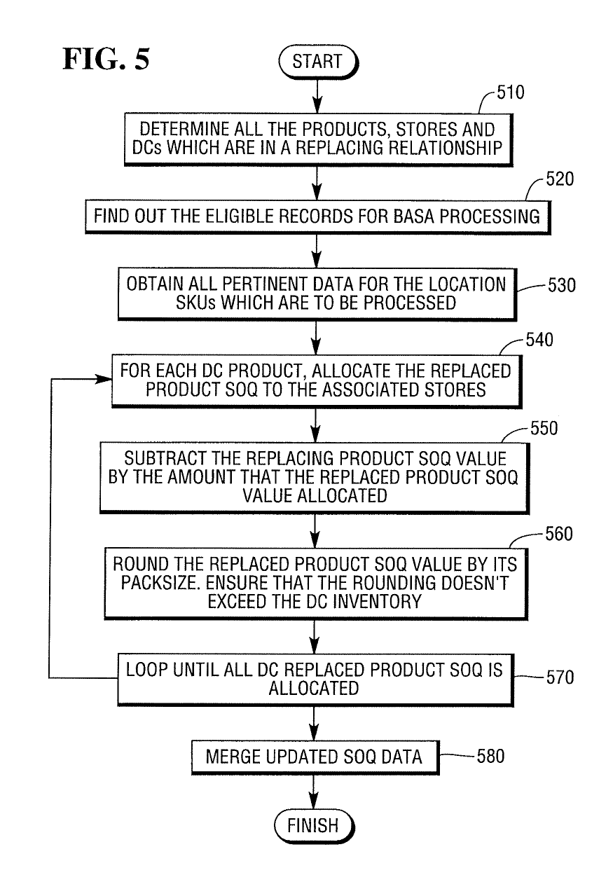

As stated above, the discontinuance or replacement of a product maintained at a distribution center raises questions regarding how best to discharge and fairly distribute the lingering inventory of the discontinued or replaced product. FIG. 5 provides a flow diagram of a process for optimally clearing out the inventory of a replaced/discontinued product at a Distribution Center, keeping in mind the demand of the replacing product at the stores supported by the Distribution Center. This process is executed by a module, referred to herein as the Buy-Around-Split-Around (BASA) module, included within Automated Replenishment module 415.

Referring to FIG. 5, the BASA module in step 510 determines all the products, stores and DCs which are in a replacing relationship. This procedure identifies the DC locations with old (replaced) products and calculates the onhand quantity of those replaced products. The onhand quantity is adjusted keeping in mind the replaced product forecasts for that DC location and product.

In steps 520 and 530, DCM records subject to BASA processing are identified, and pertinent data concerning products or SKUs (stock keeping units) subject to BASA processing is obtained. Pertinent data includes: the DC location; the corresponding store locations; the replaced (old) product, the replacing (new) product; the replaced product onhand quantity present in the DC; rounding information concerning the replaced and replacing products; and the suggested order quantities for the replacing product.

In step 540, for each DC product, order quantities for the replaced (old) product are allocated to the stores associated with the DC and product. In step 550 the quantity of replaced (old) product allocated to the store in step 540 is subtracted from the replacing (new) product SOQ value requested by the store. If the replaced product is shipped in a pack comprising a quantity of the product contained within a single package, the replaced product suggested order quantity is rounded down to ensure that the product quantity exceed the DC inventory, as shown in step 560.

Steps 540 through 560 are repeated until all DC replaced (old) product suggested order quantities are allocated.

In step 580, the updated replaced and replacing product SOQ data is merged and stored within the DCM database.

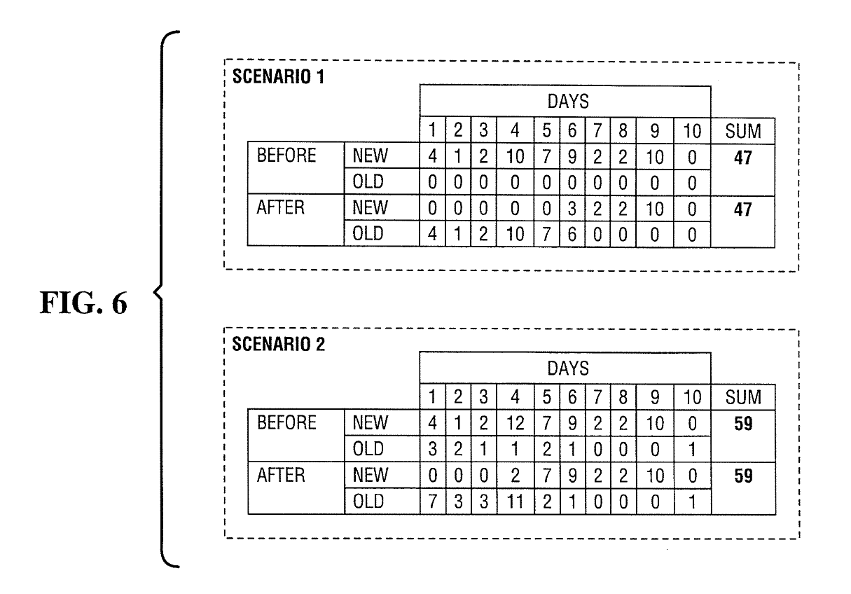

Sample calculations for the BASA module are illustrated in the tables of FIG. 6. Two examples, identified as scenarios 1 and 2 are illustrated. Both of the scenarios show the SOQ values for two products over a period of 10 days, one product being the replacing (new) product and the other being the replaced (old) product. The before rows and cells show the new and old product SOQ values before application of the BASA process, and the after rows and cells show the adjusted new and old product SOQ values after application of the BASA process. The sum of the new and old products is the same in both before and after scenarios.

In the table titled Scenario 1, days 1 through 5, all the SOQ values are shown being transferred from the replacing (new) product to the replaced (old) product. On day 6, only a portion of the SOQ value, 6 units out of 9, is transferred because as only 6 units of the replaced (old) product remain for allocation in DC onhand inventory. There are no changes to new and old product SOQ values in days 7 and beyond as all replaced product has been allocated.

Similarly, in the table titled Scenario 2, days 1 through 3, all the SOQ values are shown being transferred from the replacing (new) product to the replaced (old) product. On day 4, a portion of the SOQ value, 10 units out of 12, is transferred because as only 10 units of the replaced (old) product are available for allocation from DC onhand inventory. There are no changes to new and old product SOQ values in days 5 and beyond as all replaced product has been allocated.

### CONCLUSION

The Figures and description of the invention provided above reveal a novel system and method for optimally clearing out the inventory of a replaced/discontinued product at a Distribution Center, keeping in mind the demand of the replacing product at the stores supported by the Distribution Center. The described system and method calculates replaced (old) and replacing (new) product suggested order quantities; rounds the replaced and replacing product suggested order quantities if necessary due to product packaging; and ensures that the aggregate of the replaced suggested order quantity doesn't exceed DC onhand inventory.

The BASA module utilizes the power of a relational database to solve the business problem related to having unallocated SKUs at a Distributed Center. The BASA module was developed using Teradata Stored Procedures and SQL queries. This approach enables the execution of the module entirely on a database with no requirements for application nodes. Running the BASA module on a database using stored procedures bypasses resource constraints such as hitting the maximum number of concurrent fastload/fastexport sessions. No scheduling algorithm is needed. The performance of the module is linearly scalable over the number of records processed as it takes advantage of Teradata's parallel architecture. Additionally, the workload of the BASA module can be analyzed and controlled using Teradata utilities such as Teradata Workload Analyzer, Performance Monitor, Teradata Dynamic Workload Manager, etc. This would not have been possible if the module was executing on an application node.

Instructions of the various software routines discussed herein, such as the methods illustrated in FIG. 5, are stored on one or more storage modules in the system shown in FIGS. 1 and 3 and loaded for execution on corresponding control units or processors. The control units or processors include microprocessors, microcontrollers, processor modules or subsystems, or other control or computing devices. As used here, a “controller” refers to hardware, software, or a combination thereof. A “controller” can refer to a single component or to plural components, whether software or hardware.

Data and instructions of the various software routines are stored in respective storage modules, which are implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

The instructions of the software routines are loaded or transported to each device or system in one of many different ways. For example, code segments including instructions stored on floppy disks, CD or DVD media, a hard disk, or transported through a network interface card, modem, or other interface device are loaded into the device or system and executed as corresponding software modules or layers.

The foregoing description of various embodiments of the invention has been presented for purposes of illustration and description. It is not intended to be exhaustive or to limit the invention to the precise form disclosed. Many alternatives, modifications, and variations will be apparent to those skilled in the art in light of the above teaching. Accordingly, this invention is intended to embrace all alternatives, modifications, equivalents, and variations that fall within the spirit and broad scope of the attached claims.

What is claimed is:

1. A computer-implemented method for distributing inventory of a discontinued product from a distribution center to a plurality of stores, the method comprising the steps of:
receiving, by a computer, from each one of said plurality of stores a replacing product store order quantity for a replacing product, said replacing product being a replacement for a replaced product;
for each one of said plurality of stores, allocating, by said computer, a replaced product store order quantity for said replaced product not to exceed said replacing product store order quantity; and
for each one of said plurality of stores, subtracting, by said computer, the replaced product store order quantity from said replacing product store order quantity to determine an updated replacing product store order quantity.

2. The method in accordance with claim 1, wherein:
said replacing product store order quantity, said replacement product store order quantity, and said updated replacing product store order quantity are daily order quantities.

3. The method in accordance with claim 1, wherein:
said replaced product is provided in a package containing multiple units of said replaced product, said multiple units of said replaced product being a packsize for said replaced product; and
said method further includes the step of for each one of said plurality of stores, rounding, by said computer, said replaced product store order quantity by the packsize of said replaced product.

4. The method in accordance with claim 3, further comprising the steps of:
summing, by said computer, the replaced product store order quantities for all of said plurality of stores;
comparing said sum of said replaced product store order quantities with a remaining distribution center inventory of said replaced product; and
reducing one or more of said replaced product store order quantities if said sum of said replaced product store order quantities exceeds said remaining distribution center inventory of said replaced product.

5. A system for distributing inventory of a discontinued product from a distribution center to a plurality of stores, the system comprising:
a computer for:
receiving from each one of said plurality of stores a replacing product store order quantity for a replacing product, said replacing product being a replacement for a replaced product;
for each one of said plurality of stores, allocating a replaced product store order quantity for said replaced product not to exceed said replacing product store order quantity; and
for each one of said plurality of stores, subtracting the replaced product store order quantity from said replacing product store order quantity to determine an updated replacing product store order quantity.

6. The system in accordance with claim 5, wherein:
said replacing product store order quantity, said replacement product store order quantity, and said updated replacing product store order quantity are daily order quantities.

7. The system in accordance with claim 5, wherein:
said replaced product is provided in a package containing multiple units of said replaced product, said multiple units of said replaced product being a packsize for said replaced product; and
for each one of said plurality of stores, said computer rounds said replaced product store order quantity by the packsize of said replaced product.

8. The system in accordance with claim 7, wherein said computer:
sums the replaced product store order quantities for all of said plurality of stores;
compares said sum of said replaced product store order quantities with a remaining distribution center inventory of said replaced product; and
reduces one or more of said replaced product store order quantities if said sum of said replaced product store order quantities exceeds said remaining distribution center inventory of said replaced product.

9. A computer program, stored on a tangible storage medium, for distributing inventory of a discontinued product from a distribution center to a plurality of stores, the program including executable instructions that cause a computer to:
for each one of a plurality of stores:
receive a replacing product store order quantity for a replacing product, said replacing product being a replacement for a replaced product;
allocate a replaced product store order quantity for said replaced product not to exceed said replacing product store order quantity; and
subtract the replaced product store order quantity from said replacing product store order quantity to determine an updated replacing product store order quantity.

10. The computer program, stored on a tangible storage medium, in accordance with claim 9, wherein:
said replacing product store order quantity, said replacement product store order quantity, and said updated replacing product store order quantity are daily order quantities.

11. The computer program, stored on a tangible storage medium, in accordance with claim 9, wherein:
said replaced product is provided in a package containing multiple units of said replaced product, said multiple units of said replaced product being a packsize for said replaced product; and
for each one of said plurality of stores, said computer in accordance with said instructions rounds said replaced product store order quantity by the packsize of said replaced product.

12. The computer program, stored on a tangible storage medium, in accordance with claim 11, wherein said executable instructions cause said computer to:
sum the replaced product store order quantities for all of said plurality of stores;
compare said sum of said replaced product store order quantities with a remaining distribution center inventory of said replaced product; and
reduce one or more of said replaced product store order quantities if said sum of said replaced product store order quantities exceeds said remaining distribution center inventory of said replaced product.
